(19) United States
(12) Patent Application Publication
(10) Pub. No.: US 2026/0216821 A1
(43) Pub. Date: Jul. 30, 2026

(54) METHOD FOR THE LASER WELDING OF COMPONENTS, AND ASSEMBLY OF COMPONENTS

(71) Applicant: TRUMPF Laser- und Systemtechnik SE, Ditzingen (DE)

(72) Inventor: Patrick Haug, Unteriflingen (DE)

(21) Appl. No.: 19/463,160

(22) Filed: Jan. 29, 2026

Related U.S. Application Data
(63) Continuation of application No. PCT/EP2024/070660, filed on Jul. 22, 2024.

(30) Foreign Application Priority Data
Aug. 14, 2023 (DE) 10 2023 121 736.4

(51) Int. Cl. B23K 26/073; B23K 26/244

(52) U.S. Cl. CPC B23K 26/0734; B23K 26/244

(57) ABSTRACT

A method for laser welding of components includes providing at least two components. At least one component of the at least two components is coated. The at least two components comprise high-strength steel. The method further includes producing at least three laser spots on at least one surface of at least a first component of the at least two components. Each of the at least three laser spots has a core region and a ring region. An average laser power density in the core region is higher than an average laser power density in the ring region. The at least three laser spots produce a common molten pool in the at least two components.

### CROSS REFERENCE TO RELATED APPLICATIONS

This application is a continuation of International Application No. PCT/EP2024/070660 (WO 2025/036654 A1), filed on Jul. 22, 2024, and claims benefit to German Patent Application No. DE 10 2023 121 736.4, filed on Aug. 14, 2023. The aforementioned applications are hereby incorporated by reference herein.

### FIELD

Embodiments of the present invention relate to a method for the laser welding of components.

### BACKGROUND

High-strength components are used particularly in automotive engineering (body construction). The components are generally high-strength steel sheets with an aluminum-silicon coating. Welding such components together can be done using a laser. In this process, aluminum from the coating of the sheets can enter the welding seam and have an adverse effect on the martensitic transformation or martensite formation. Furthermore, aluminum can cause the formation of intermetallic phases, which can serve as a starting point for crack formation.

DE 10 2019 131 906 A1 discloses a method for welding coated steel sheets using two laser beams, wherein the laser beams are moved relative to one another.

### SUMMARY

Embodiments of the present invention provide a method for laser welding of components. The method includes providing at least two components. At least one component of the at least two components is coated. The at least two components comprise high-strength steel. The method further includes producing at least three laser spots on at least one surface of at least a first component of the at least two components. Each of the at least three laser spots has a core region and a ring region. An average laser power density in the core region is higher than an average laser power density in the ring region. The at least three laser spots produce a common molten pool in the at least two components.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a method for the laser welding of components according to a first exemplary embodiment;

FIG. 2 shows a schematic view of the method for the laser welding of components according to a second exemplary embodiment; and

FIG. 3 shows a schematic view of the method for the laser welding of components according to a third exemplary embodiment.

### DETAILED DESCRIPTION

Embodiments of the present invention provide a method for the laser welding of components and an arrangement of components, wherein the above disadvantages are eliminated.

According to some embodiments, a method for the laser welding of components comprises the steps of:

providing at least two components. At least one of the components has a coating. This could be an aluminum-silicon coating. The components are made of high-strength steel. The components can be made of sheet steel. The high-strength steel could be an MnB (manganese boron) steel, e.g., 22mnB5.

In this case, “high-strength” refers to a metal with a yield strength of at least 550 MPa (megapascals), in particular at least 1000 MPa, preferably at least 1500 MPa, and more preferably at least 2000 MPa.

Producing at least three, in particular four, laser spots on at least one surface of at least one component. The laser spots each have a core region and a ring region. The respective core region can be circular in shape. The respective ring region can be annular in shape. Other geometric shapes, such as ovals, are also conceivable. The average laser power density in the core region of a laser spot is higher than the average laser power density in the ring region (of the same laser spot). The laser spots produce a common molten pool in the components.

To produce the laser spots, at least one infrared laser with a wavelength in a range of 800 nm (nanometers) to 1200 nm, in particular 1030 nm or 1070 nm, can be used.

Alternatively or additionally, at least one laser with a wavelength in the visible range (VIS laser), in particular in a range of 400 nm to 450 nm (blue), in particular of 515 nm (green), can be used.

To produce the laser spots, a scanner optic with an imaging ratio in a range of 1:1 to 5:1, in particular in a range of 1.5:1 to 2:1, preferably 1.9:1, more preferably 2.5:1, can also be used.

Alternatively, a fixed optic can be used for producing the laser spots. The fixed optic can have an imaging ratio of 1:1.

This allows energy to be introduced in a targeted manner, thus optimizing mixing in the molten pool. The formation of critical, intermetallic phases can thus be suppressed. In this way, a high-quality and uniform welding seam with constant mechanical properties can be achieved. This allows high-strength and coated components to be reliably welded together with reproducible, high quality, and in particular tailored welded blanks (workpieces made from individual sheet metal blanks) to be manufactured in automotive engineering (body construction).

The welding depth using this method can be less than 10 mm (millimeters), in particular equal to or less than 4 mm.

It is conceivable that the average laser power density can be adjusted in the core region and/or in the ring region (in particular before the welding process). The power output in the core region can range from greater than 0% to less than 100% of the laser power or the power of an output laser beam.

According to a further development, the method can comprise the steps of:

arranging the components in a butt joint and/or arranging the components in a lap joint. In a lap joint, the components are arranged one above the other (with respect to a direction along which the laser spots hit the surface). In a butt joint, the components are arranged next to each other in the same plane (with respect to a direction along which the laser spots hit the surface).

It is also conceivable that the components can be arranged in a parallel joint (two or more components arranged parallel and flat), an oblique joint (one component arranged obliquely to another component), a multiple joint (three or more components arranged with their edges abutting each other), a T-joint (one component arranged at right angles to another component (T-shaped)), a corner joint (two components arranged abutting each other at an angle) and/or a cross joint (two components arranged crosswise to each other). A combination of the individual joint types is also conceivable.

This allows the components to be arranged very flexibly, making it possible to implement a multitude of different and complex geometries of welded components.

According to a further development, the method can comprise the step of:

moving the laser spots in a feed direction along a weld path. Thus, the laser spots can only be moved in the feed direction along the weld path.

In this context, the feed direction refers to a local directional parameter. The feed direction can depend on the course of the weld path. The feed direction can change its orientation or alignment depending on the course of the weld path.

The laser spots can be held statically in relation to the weld path. In other words, the laser spots are in particular not rotated and/or not moved transversely to the weld path. In particular, the laser spots do not change their relative position with respect to the weld path. The laser spots can be held statically (unmoving) relative to one another.

At least two laser spots can be arranged one behind the other along the feed direction, at least partially, and in particular completely. At least two laser spots can overlap each other, at least partially, along the feed direction. Thus, there can always be, at least partially, one laser spot that leads in the feed direction and/or along the weld path, and another laser spot that trails. This allows two laser spots to be moved at least partially over the same region of a component or its surface.

Two laser spots arranged one behind the other (in the feed direction) can be arranged exactly one behind the other with respect to the feed direction or laterally offset from each other.

For example, with four laser spots, it is conceivable to arrange them in a square pattern. The four laser spots can each represent a corner of the square in the square arrangement. It is conceivable to orient this square laser spot arrangement in such a way that the edges of the square of the square laser spot arrangement are oriented parallel or perpendicular to the feed direction. Then, two laser spots are arranged exactly one behind the other in the feed direction.

It is also conceivable to rotate the square arrangement by 90° with respect to the feed direction, so that the edges of the square of the square laser spot arrangement are each inclined by 45° to the feed direction. This means that the laser spots are arranged in a (square) rhombus with respect to the feed direction. This means that three laser spots are arranged laterally or diagonally offset one behind the other in the feed direction. A lateral (oblique) offset of the laser spots in the feed direction would also be conceivable with a triangular laser spot arrangement using only three laser spots.

The distance between any two adjacent laser spots (or their centers) can be kept constant. The distance can be 400 µm (micrometers). In this context, “adjacent laser spots” refers to the nearest laser spots.

Alternatively, it is conceivable that the distance between two adjacent laser spots (or their centers) can be varied or oscillated.

This allows the energy input to be specifically distributed to a desired region and the mixing of the molten pool to be adjusted as desired and/or further optimized.

According to a further development, the method can comprise the step of:

adding an additional molten material to the molten bath. The molten material can be a welding wire, in particular an endless welding wire.

By adding the additional molten material, a desired alloy composition can be achieved.

According to a further development, the method can comprise the step of:

varying, in particular oscillating, the mean laser power density of at least one laser spot, its core region and/or its ring region. It is conceivable that the average laser power density of all laser spots, their respective core regions and/or their respective ring regions can be varied, in particular oscillated.

Varying (or oscillating) the average laser power density can be implemented particularly during the welding process. The total laser power can be varied or oscillated during the welding process.

This allows the degree of mixing in the molten pool to be further increased or adjusted as desired.

According to a further development of the method, the core region of at least one laser spot, in particular of all laser spots, can have a diameter in a range of 50 µm to 400 µm, in particular in a range of 50 µm to 200 µm, preferably 200 µm.

Alternatively or additionally, the ring region of at least one laser spot, in particular of all laser spots, can have an outer diameter in a range of 40 µm to 2000 µm, in particular in a range of 80 µm to 800 µm, preferably 700 µm.

The ring region of at least one laser spot, in particular of all laser spots, has in particular an inner diameter that corresponds to the diameter of the respective core region. In other words, the inner diameter of the ring region and the diameter of the respective core region can be the same.

It is also conceivable that the ring region (or its inner diameter) is arranged at a distance from the core region (or its outer diameter). In other words, the inner diameter of the ring region can be larger than the outer diameter of the core region. It is conceivable that a distance of, for example, approximately 10 µm could be arranged between the ring region and the core region. Thus, an intensity gap can be arranged between the core region and the ring region.

The ratio between the diameter of the core region and the outer diameter of the respective ring region can be in a range of 1:2 to 1:10, in particular 1:4.

The core region and the ring region of at least one laser spot, in particular of all laser spots, can each be arranged concentrically. The core region and the ring region of at least one laser spot, in particular of all laser spots, can each be arranged in a circle around a center of the respective laser spot.

By shaping the laser spots in this way, the energy distribution or energy input into the molten pool can be further optimized.

According to a further development of the method, at least two, and in particular all, laser spots can be designed identically. It is also conceivable that at least two, in particular all, laser spots may be shaped differently.

This simplifies the production of individual laser spots and/or makes the energy distribution more uniform.

According to a further development of the method, the ring regions of at least two, in particular all, laser spots can overlap each other.

Due to the overlap of the ring regions, the energy input can be further optimized.

According to a further development of the method, the core regions of at least two, in particular all, laser spots can be arranged at a distance from each other. Core regions of at least two, in particular of all, laser spots can be arranged without overlapping one another. In other words, the core regions preferably do not overlap.

The spaced-apart core regions allow the energy intensities to be distributed over a larger surface, thus further optimizing the energy input.

It is conceivable that at least two, and in particular all, laser spots can be arranged at a distance from each other. At least two, and in particular all, laser spots can be arranged without overlapping one another. In other words, the laser spots preferably do not overlap.

The core regions and/or the ring regions of at least two, in particular all, laser spots can be arranged at a distance from each other. The ring regions of at least two adjacent laser spots can (at their respective outer diameters) touch (have at least one common point).

It is conceivable that at least two, in particular all, laser spots, whose core regions and/or their ring regions may be arranged in an overlapping manner. For example, the ring regions of at least two (adjacent) laser spots can overlap. It is conceivable that a ring region of a laser spot overlaps the core region of a neighboring laser spot.

When welding two components (e.g., in a butt joint arrangement) using four laser spots, two laser spots can be arranged one behind the other in the feed direction. The four laser spots can be arranged in a square configuration (i.e., forming a square). In each case, two laser spots may be arranged on the component. The four laser spots can be arranged in such a way that the weld path runs between two pairs of laser spots arranged one behind the other in the feed direction.

This allows the energy input to be distributed as optimally as possible over a given surface.

According to a further development of the method, at least one laser spot, in particular all laser spots, can be produced using an optical multi-fiber. The multi-fiber can be a 2-in-1 fiber. The multi-fiber may have a core fiber which is enclosed by a ring fiber. The multi-fiber can transform an output laser beam into partial beams, wherein the laser spot or laser spots can be formed from the respective partial beams. The individual partial beams allow the core region and the ring region to be realized with different laser power densities.

The output laser beam can be produced using a disk laser (multi-mode). A beam splitter may be provided that divides the output laser beam into two components (core region and ring region).

At least one laser spot, in particular all laser spots, can be produced using a ring fiber that is fed from a plurality of laser modules.

This makes the production of the laser spot or laser spots as simple as possible.

According to a further development of the method, at least two laser spots, in particular all laser spots, can each be produced using a separate optical fiber. Additionally or alternatively, at least two, in particular all, laser spots can each be produced using a separate laser.

This allows the individual laser spots to be manufactured and/or adjusted flexibly and individually.

According to some embodiments, an arrangement of at least two integrally bonded components is provided. The arrangement of components is produced using a method as described above. With regard to the advantages that can be achieved, reference is made to the relevant embodiments relating to the method. For further refinement of the arrangement of components, the measures described in connection with the method and/or the measures explained below may be employed.

In the following description and in the figures, corresponding components and elements have the same reference signs. For the sake of better clarity, all reference signs are not reproduced in all of the figures.

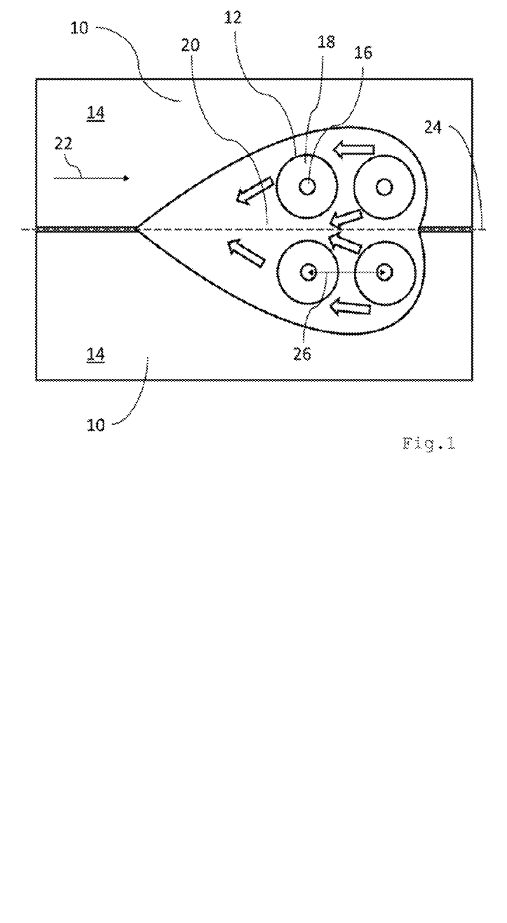

FIG. 1 shows a schematic view of a method for the laser welding of components 10 according to a first exemplary embodiment. A top view of the components 10 is shown.

In the present case, two components 10 are arranged in a butt joint. It is likewise conceivable that more components 10 and/or a different joint configuration may be provided. The components 10 are made of high-strength steel. The components 10 can be steel sheets. In the present case, both components 10 have a coating, in particular an aluminum-silicon coating.

The components 10 each have a surface 14. Four laser spots 12 are produced on the surfaces 14 of each of the two components 10. It is also conceivable that three or more than four laser spots 12 can be produced on the surfaces 14 of the two components 10.

The laser spots 12 can be produced using an optical multi-fiber, in particular a 2-in-1 fiber. The laser spots 12 can be produced by means of an output laser beam (from a laser) which is divided into partial beams by means of the multi-fiber. It is also conceivable that the laser spots 12 can be produced by means of a plurality of output laser beams (from separate lasers).

In the present case, the four laser spots 12 are arranged in a square arrangement. In other words, the four laser spots 12 are arranged in the shape of a square. Each of the four laser spots 12 forms a corner of the square. Two laser spots 12 are arranged on each component 10 or its respective surface 14.

Each laser spot 12 has a core region 16 and a ring region 18. In this case, the core regions 16 are circular in shape. In the present case, the ring regions 18 are formed in a ring shape. It is conceivable that the core regions 16 and/or the ring regions 18 may each have a different geometric shape (e.g., oval).

In the present case, the four laser spots 12 are each designed identically. It is also conceivable that the four laser spots 12 could be configured differently. The laser spots 12 produce a common molten pool 20 in the components 10.

The laser spots 12 each have a core region 16 with a diameter of 100 µm. In the present case, the ring regions 18 of the laser spots 12 each have a diameter of 400 µm. The core regions 16 and the ring regions 18 of the respective laser spots 12 are arranged concentrically in this case.

Within the core regions 16 of the laser spots 12, the mean laser power density is greater than the mean laser power density within the respective ring regions 18.

The laser spots 12 can be moved in a feed direction 22 along a weld path 24. In this case, the weld path 24 runs between the two components 10. The feed direction 22 is a local variable. The feed direction 22 depends on the course of the weld path 24. In other words, the feed direction 22 can change its orientation depending on the course of the weld path 24.

The laser spots 12 are moved exclusively in the feed direction 22 along the weld path 24. The laser spots 12 are arranged at a distance from each other. In other words, there is a distance 26 between two adjacent laser spots 12. This distance 26 is kept constant during the movement of the laser spots 12 in the feed direction 22. In other words, the laser spots 12 do not undergo any relative movement with each other. The distance 26 is greater than 400 µm in this case. The individual laser spots 12 in particular do not perform any rotational movement.

In the present case, two laser spots 12 are arranged one behind the other in the feed direction 22 on each component 10 (square arrangement of the laser spots 12). This results in a leading laser spot 12 and a trailing laser spot 12 on each component 10 or its respective surface 14. In this case, the same region of the respective component 10 or its surface 14 is processed by two laser spots 12 (one after the other). In other words, two laser spots 12 are arranged exactly one behind the other in the feed direction 22. It is also conceivable that the laser spots 12 can be arranged obliquely or laterally offset one behind the other in the feed direction 22, e.g., in a diamond-shaped arrangement with respect to the feed direction 22 or in the case of three laser spots 12 and a triangular arrangement.

The movement of the laser spots 12 in the feed direction 22 and the square-shaped arrangement of the laser spots 12 result in a flow direction within the molten pool 20 that is substantially directed against the feed direction 22. The flow direction of the molten pool 20 is indicated by arrows in FIG. 1.

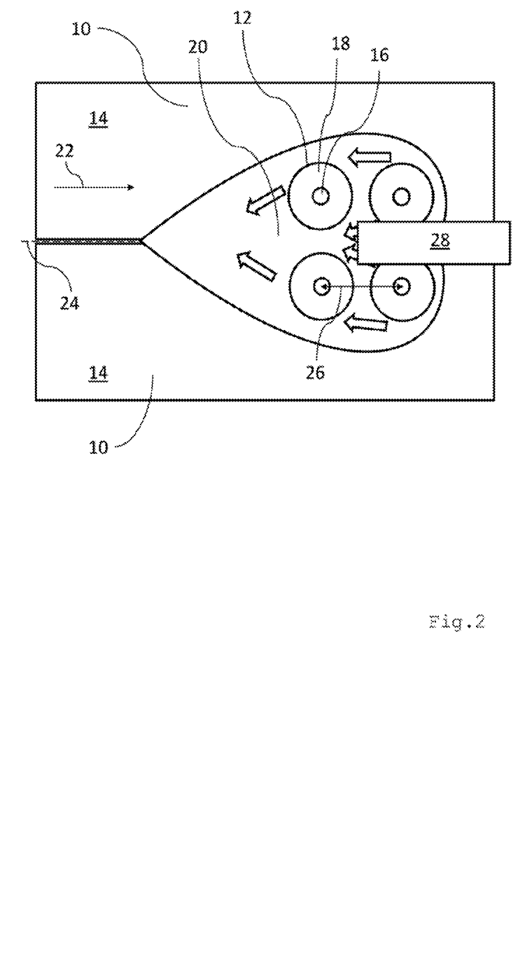

FIG. 2 shows a schematic view of the method for the laser welding of components 10 according to a second exemplary embodiment.

The second exemplary embodiment of the method differs from the first exemplary embodiment shown in FIG. 1 in the following ways:

additional molten material is added to the molten pool 20. In this case, the additional molten material is designed as welding wire 28.

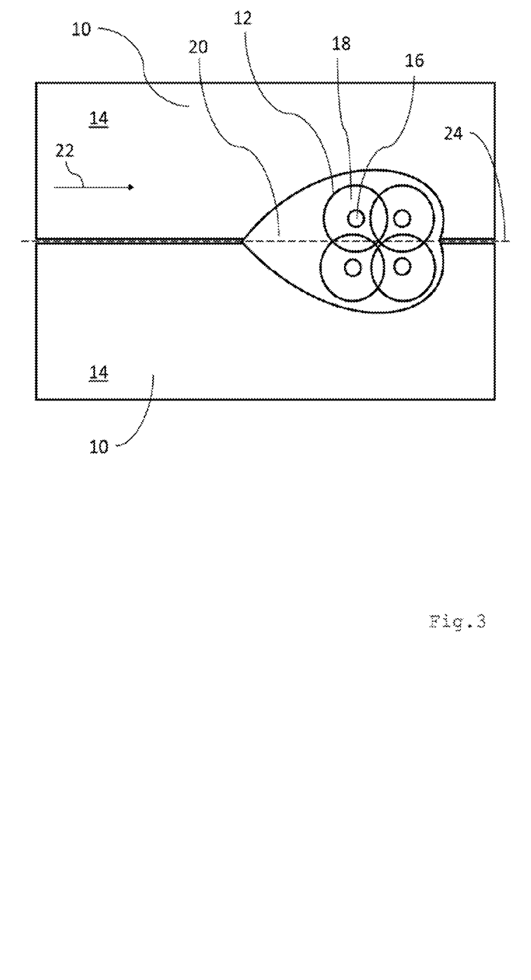

FIG. 3 shows a schematic view of the method for the laser welding of components 10 according to a third exemplary embodiment.

The third exemplary embodiment of the method differs from the first exemplary embodiment shown in FIG. 1 in the following ways:

the four laser spots 12 overlap with their ring regions 18. The ring regions 18 of each pair of adjacent laser spots 12 are designed or arranged to overlap each other.

The core regions 16 of the four laser spots 12 are arranged at a distance from each other. In other words, the core regions 16 of the four laser spots 12 do not overlap. The distance between the core regions 16 of two adjacent laser spots 12 is smaller compared to the first exemplary embodiment shown in FIG. 1. The laser spots 12 have been arranged closer together (in comparison with FIG. 1).

In the present case, the core region 16 and the ring region 18 of two adjacent laser spots 12 do not overlap. However, it is conceivable that the laser spots 12 can be arranged in such a way that the core region 16 and the ring region 18 of at least two adjacent laser spots 12 overlap.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for laser welding of components, the method comprising:
providing at least two components, at least one component of the at least two components being coated, and the at least two components comprising high-strength steel; and
producing at least three laser spots on at least one surface of at least a first component of the at least two components, each of the at least three laser spots having a core region and a ring region, an average laser power density in the core region being higher than an average laser power density in the ring region, and the at least three laser spots producing a common molten pool in the at least two components.

2. The method according to claim 1, wherein the at least one component has an aluminum-silicon coating.

3. The method according to claim 1, further comprising:
arranging the at least two components in a butt joint, and/or
arranging the at least two components in a lap joint.

4. The method according to claim 1, further comprising:
moving the at least three laser spots in a feed direction, wherein at least two laser spots of the at least three laser spots are arranged at least partially one behind the other along the feed direction.

5. The method according to claim 4, wherein the at least two laser spots are arranged completely one behind the other along the feed direction, and a distance between the at least two laser spots is kept constant.

6. The method according to claim 1, further comprising:
adding an additional molten material to the molten pool.

7. The method according to claim 6, wherein the additional molten material comprises a welding wire.

8. The method according to claim 1, further comprising:
varying the average laser power density of at least one laser spot of the at least three laser spots, in the core region or in the ring region.

9. The method according to claim 1, wherein the core region of at least one laser spot of the at least three laser spots has a diameter in a range of 50 µm to 400 µm, and/or the ring region of at least one laser spot of the at least three laser spots has an outer diameter in a range of 40 µm to 2000 µm.

10. The method according to claim 1, wherein the core region and the ring region of at least one laser spot of the at least three laser spots are arranged concentrically.

11. The method according to claim 1, wherein at least two laser spots of the at least three laser spots are configured identically.

12. The method according to claim 1, wherein the ring regions of at least two laser spots of the at least three laser spots overlap each other.

13. The method according to claim 1, wherein the core regions of at least two laser spots of the at least three laser spots are arranged apart from each other.

14. The method according to claim 1, wherein at least one laser spot of the at least three laser spots is produced by an optical multi-fiber.

15. The method according to claim 1, wherein each of the at least three laser spotsis produced by a separate optical fiber and/or by a separate laser.

16. An arrangement of at least two integrally bonded components, wherein the arrangement is produced by a method according to claim 1.
